(19) United States
(12) Patent Application Publication
(10) Pub. No.: US 2022/0046157 A1
(43) Pub. Date: Feb. 10, 2022

(54) METHOD AND PROCESSING DEVICE FOR PROCESSING MEASURED DATA OF AN IMAGE SENSOR

(71) Applicant: Robert Bosch GmbH, Stuttgart (DE)

(72) Inventors: Marc Geese, Ostfildern Kemnat (DE); Ulrich Seger, Leonberg-Warmbronn (DE)

(21) Appl. No.: 17/417,999

(22) PCT Filed: Dec. 17, 2019
(86) PCT No.: PCT/EP2019/085555

§ 371 Date: Sep. 2, 2021

(30) Foreign Application Priority Data
Dec. 25, 2018 (DE) 10 2018 222 903.1

(51) Int. Cl. H04N 5/235; G06T 7/70; G06K 9/62

(52) U.S. Cl. CPC H04N 5/2351; G06T 2207/20081; G06K 9/6256; G06T 7/70

(57) ABSTRACT

A method for processing measured data of an image sensor. The method includes reading in measured data that have been recorded by light sensors in the surroundings of a reference position on the image sensor. The light sensors are situated around the reference position on the image sensor. Weighting values are read in, each of which is associated with the measured data of the light sensors in the surroundings of a reference position, the weighting values for light sensors situated at an edge area of the image sensor differing from weighting values for light sensors situated in a central area of the image sensor, and/or the weighting values being a function of a position of the light sensors on the image sensor. The method includes linking the measured data of the light sensors to the associated weighting values to obtain image data for the reference position.

### FIELD

The present invention is directed to a method or a processing device. Moreover, the subject matter of the present invention relates to a computer program.

### BACKGROUND INFORMATION

In conventional optical recording systems, a problem often arises with regard to sufficiently precise imaging of images by an image sensor, due to the fact that, for example, imaging errors of optical components of a real object assume a different type of shape in the center of the image sensor compared to imaging of the object in the edge area of the image sensor. At the same time, different imaging properties of colors or color patterns may occur at different positions of the image sensor, which result in a suboptimal representation or depiction of the real object by the image sensor. In particular, due to the color filter mask, all colors of the color filter mask are not available at every location on the image sensor.

### SUMMARY

In accordance with example embodiments of the present invention, a method, a processing device that uses this method, and a corresponding computer program are provided. Advantageous refinements and enhancements of the processing device are possible by use of the measures set forth herein.

In accordance with the present invention, a method for processing measured data of an image sensor is provided. In an example embodiment of the present invention, the method includes the following steps:
reading in measured data that have been recorded by light sensors in the surroundings of a reference position on the image sensor, the light sensors being situated around the reference position on the image sensor, in addition weighting values being read in, each of which is associated with measured data of the light sensors in the surroundings of a reference position, the weighting values for light sensors situated at an edge area of the image sensor differing from weighting values for light sensors situated in a central area of the image sensor, and/or the weighting values being a function of a position of the light sensors on the image sensor; and
linking the measured data of the light sensors to the associated weighting values in order to obtain image data for the reference position.

Measured data may be understood to include data that have been recorded by a light sensor or other measuring units of an image sensor, and that represent a depiction of a real object on the image sensor. A reference position may be understood to mean, for example, a position of a light property (for example, a red filtered spectral range) on a light sensor for which other light properties (green and blue, for example) are to be computed, or whose measured value is to be processed or corrected. The reference positions form, for example, a uniform point grid which allows the generated measured data to be represented, without further postprocessing, as an image on a system using an orthogonal display grid, for example (a digital computer display, for example). The reference position may match a measuring position or the position of an existing light sensor, or may be situated at an arbitrary location of the sensor array spanned by the x and y axes, as described in greater detail below. The surroundings around a reference position of an image sensor may be understood to mean the light sensors that are adjacent to the reference position in the adjoining other rows and/or columns of the light sensor raster of an image sensor. For example, the surroundings around the reference position form a rectangular two-dimensional structure in which N×M light sensors having different properties are situated.

A weighting value may be understood to mean, for example, a factor that is linked to the measured values of the light sensors in the surroundings of the reference position or weighted, for example multiplied, and the result is subsequently summed to obtain the image data for the reference position. The weighting values for light sensors may differ as a function of the position on the sensor, for example based on identical light sensor types, i.e., light sensors that are designed to record the same physical parameters. This means that the sensor values or measured data values of light sensors that are situated in an edge area of the image sensor are weighted differently than the measured data values or values of light sensors that are situated in a central area of the image sensor. Linking may be understood to mean, for example, multiplication of measured values of the light sensors (i.e., the light sensors in the surroundings of the reference position) by the particular associated weighting values, followed, for example, by addition of the particular weighted measured data values of these light sensors.

The approach presented here is based on the finding that, due to the weighting of the measured data of light sensors as a function of the particular position on the image sensor, a technically very simple and elegant option results for allowing compensation for unfavorable imaging properties (such as location-dependent or thermal changes in the point response (point spread function)) of optical components (such as lenses, mirrors or the like) or the conventional image sensor itself, without the need for a new, higher-resolution, costly image sensor that operates with high precision, or a costly optical system that images without errors. This unfavorable imaging property may thus be corrected by weighting the measured data with weighting factors or weighting values that are a function of a position of the light sensor in question on the image sensor, the weighting values being trained or ascertained, for example, in a preceding method or during runtime. This training may be carried out, for example, for an appropriate combination of an image sensor and optical components, i.e., for a specific optical system, or for groups of systems having similar properties. The trained weighting values may be subsequently stored in a memory and read out at a later point in time for the method provided here.

One specific embodiment of the present invention is advantageous in which in the step of reading in, measured data of light sensors are read in, which are respectively situated in a different row and/or a different column on the image sensor in relation to the reference position, in particular the light sensors completely surrounding the reference position. In the present case, a row may be understood to mean an area having a predetermined distance from an edge of the image sensor. In the present case, a column may be understood to mean an area having a predetermined distance from another edge of the image sensor, the edge that defines the column being different from an edge that defines the row. In particular, the edge, by which the rows are defined, may extend in a different direction or perpendicularly with respect to the edge, by which the columns are defined. As a result, areas on the image sensor may be distinguished without the light sensors themselves being positioned symmetrically in rows and columns on the image sensor (image sensor built up in the form of a matrix). Rather, the aim is merely to ensure that the light sensors in the surroundings of the reference position are situated around the reference position at multiple different sides. Such a specific embodiment of the approach presented here offers the advantage that the image data for the reference position may be corrected, taking into account effects or measured values of light sensors that are to be observed in the immediate vicinity around the reference position. For example, a continuously increasing change in the point imaging of a real object from a central area of the image sensor toward an edge area may thus be taken into account or compensated for very precisely.

According to a further specific embodiment of the present invention, in the step of reading in, measured data may be read in from the light sensors, which are respectively designed to record measured data in different parameters, in particular colors, exposure times, the brightnesses, or other technical lighting parameters. Such a specific embodiment of the approach presented here allows the correction of different physical parameters such as the imaging of colors, the exposure times, and/or the brightnesses at the light sensors in the different positions of the image sensor.

In addition, one specific embodiment of the approach presented here is advantageous in which a step of ascertaining the weighting values is carried out using an interpolation of weighting reference values, in particular the weighting reference values being associated with light sensors situated at a predefined distance from one another on the image sensor. The weighting reference values may thus be understood to mean supporting weighting values that represent the weighting values for individual light sensors situated at the predetermined distance and/or position from one another on the image sensor. Such a specific embodiment of the approach presented here may offer the advantage that a correspondingly associated weighting value does not have to be provided for each light sensor on the image sensor, so that a reduction of the memory space to be provided for implementing the approach presented here may be reduced. Those weighting values for a light sensor or light sensors that are situated between the light sensors on the image sensor, and with which weighting reference values are associated, may then be ascertained, via an interpolation that is technically easy to implement, as soon as these weighting values are needed.

Furthermore, one specific embodiment of the approach presented here is advantageous in which the steps of reading in and of linking are carried out repeatedly, in the repeatedly carried out step of reading in, measured data of light sensors are read that are situated at a different position on the image sensor than the measured data of the light sensors from which measured data were read in in a preceding step of reading in. Such a specific embodiment of the approach presented here allows the stepwise optimization or correction of measured data for as many reference positions of the image sensor as possible, optionally almost all reference positions that are to be meaningfully considered, so that an improvement in the imaging of the real object represented by the measured data of the image sensor is made possible.

According to a further specific embodiment of the present invention, the steps of reading in and of linking may be carried out repeatedly, in the repeatedly carried out step of reading in, measured data of the light sensors in the surroundings of the reference position being read out, which were also read in in the preceding step of reading in; in addition, in the repeatedly carried out step of reading in, different weighting values being read in for these measured data than the weighting values that were read in in the preceding step of reading in. These different weighting values may be designed, for example, for reconstructing different color properties than the reconstruction of color properties intended in the preceding step of reading in. It is also possible to use different weighting factors for the same measured values in order to obtain a different physical property of the light from the measured values. In addition, certain weighting factors may also equal zero. This may be advantageous, for example, when red color is to be determined from the measured values of green, red, and blue light sensors. In this case, it may be appropriate to weight the green and blue measured data with a factor of zero, and thus ignore them.

The multiply repeated carrying out of the above-described method, in each case with different weights, represents a special form that allows signals with different signal reconstruction objectives to be computed for each reference position. (For example, the reconstruction for the light feature of brightness with maximum resolution may require a different reconstruction than the reconstruction of the feature of color, etc.)

A light sensor type may be understood to mean, for example, the property of the light sensor for imaging a certain physical parameter of the light. For example, a light sensor of a first light sensor type may be designed to detect particularly well certain color properties of the light striking the light sensor, such as red light, green light, or white light, whereas a light sensor of another light sensor type is designed to detect particularly well the brightness or a polarization direction of the light striking this light sensor. Such a specific embodiment of the present invention may offer the advantage that the measured data detected by the image sensor may be corrected very effectively for different physical parameters, and multiple physical parameters may thus be jointly taken into account via the corresponding correction for these parameters in each case.

According to a further specific embodiment of the present invention, measured data from the light sensors of different light sensor types may also be read in in the step of reading in. Such a specific embodiment of the present invention may offer the advantage that, in the correction of the measured data for the image data at the reference position, only measured data from surroundings light sensors that correspond to different light sensor types are used. In this way, a reconstruction of the image data desired in each case at the reference position may be ensured in a very reliable and robust manner, since measured data or weighted image data from different light sensor types are linked together, and the best possible compensation may thus be made for possible errors in the measurement of light by a light sensor type.

According to a further specific embodiment of the present invention, in the step of reading in it is possible to read in the measured data from light sensors of an image sensor having, at least in part, a cyclic arrangement of light sensor types as light sensors, and/or to read in measured data from light sensors having different sizes on the image sensor, and/or to read in measured data from light sensors that each include different light sensor types that occupy a different area on the image sensor. Such a specific embodiment of the present invention may offer the advantage of being able to process or link measured data from corresponding light sensors of the light sensor types in question in a technically simple and rapid manner, without having to scale these measured data from the light sensor types in question beforehand, or prepare the measured data in some other way for a linkage.

One specific embodiment of the present invention may be implemented in a particularly technically simple manner, in which in the step of linking, the measured data of the light sensors, weighted by being multiplied by the associated weighting values, are summed in order to obtain the image data for the reference position.

One specific embodiment of the present invention is advantageous as a method for generating a weighting value matrix for weighting measured data of an image sensor, the method including the following steps:
reading in reference image data for reference positions of a reference image and training measured data of a training image, and of a starting weighting value matrix; and
training weighting values contained in the starting weighting value matrix, using the reference image data and the training measured data, in order to obtain the weighting value matrix, a linkage being formed from training measured data of the light sensors, each weighted with a weighting value, and being compared to the reference measured data for the corresponding reference position, light sensors being used that are situated around the reference position on the image sensor.

Reference image data of a reference image may be understood to mean measured data that represent an image that is regarded as optimal. Training measured data of a training image may be understood to mean measured data that represent an image that has been recorded by light sensors of an image sensor, so that, for example, the spatial variations of the imaging properties of the optical components or of the imaging properties of the image sensor or its interaction (vignetting, for example) have not yet been compensated for. A starting weighting value matrix may be understood to mean a matrix of weighting values that is initially provided, the weighting values being changed or adapted via a training in order to adapt the image data from light sensors of the training image, obtained according to one variant of the above-described approach for a method for processing measured data, to the measured data from light sensors of the reference image.

Thus, by use of the method for generating the weighting value matrix, weighting values may be generated that may be subsequently used for correcting or processing measured data of an imaging of an object by the image sensor. Specific properties may be corrected during the imaging of the real object in the measured data of the image sensor, so that the image data subsequently describe the real object in the representation form selected by the image data more favorably than the measured data that may be read out directly from the image sensor. For example, for each image sensor, each optical system, or each combination of image sensor or optical system, an individual weighting value matrix may be created in order to adequately take into account the individual manufacturing situation of the image sensor, the optical system, or the combination of image sensor or optical system.

One specific embodiment of the present invention is particularly advantageous in which in the step of reading in, an image that represents an image detail that is smaller than an image that is detectable by the image sensor is read in, in each case as a reference image and as a training image. Such a specific embodiment of the present invention may offer the advantage of a determination of the weighting value matrix that is much simpler technically or numerically, since it is not necessary to use the measured data of the entire reference image or of the training image; rather, only individual light sensor areas in the form of supporting point details at certain positions on the image sensor are used in order to compute the weighting value matrix. This may be based on the fact, for example, that a change in imaging properties of the image sensor from a central area of the image sensor toward an edge area may often be linearly approximated in sections, so that by interpolation, for example, the weighting values may be ascertained for those light sensors not situated in the area of the image detail in question of the reference image or of the training image.

Variants of the method in accordance with the present invention may be implemented, for example, in software or hardware or in a mixed form of software and hardware, for example in a processing device.

Moreover, the present invention provides a processing device that is designed to carry out, control, or implement the steps of one variant of a method provided here in appropriate units. By use of this embodiment variant of the present invention in the form of a processing device, the object underlying the present invention may also be achieved quickly and efficiently.

For this purpose, the processing device may include at least one processing unit for processing signals or data, at least one memory unit for storing signals or data, and at least one interface to a sensor or an actuator for reading in sensor signals from the sensor or for outputting data signals or control signals to the actuator and/or at least one communication interface for reading in or outputting data that are embedded in a communication protocol. The processing unit may be, for example, a signal processor, a microcontroller, or the like, it being possible for the memory unit to be a flash memory, an EEPROM, or a magnetic memory unit. The communication interface may be designed for reading in or outputting data wirelessly and/or in a hard-wired manner, it being possible for a communication interface to read in or output the hard-wired data electrically or optically, for example, from a corresponding data transmission line or output these data into a corresponding data transmission line.

In the present context, a processing device may be understood to mean an electrical device that processes sensor signals and outputs control and/or data signals as a function thereof. The processing device may include an interface that may have a hardware and/or software design. In a hardware design, the interfaces may be part of a so-called system ASIC, for example, which contains various functions of the device. However, it is also possible for the interfaces to be dedicated, integrated circuits, or to be at least partially made up of discrete components. In a software design, the interfaces may be software modules that are present on a microcontroller, for example, in addition to other software modules.

Also advantageous is a computer program product or computer program including program code that may be stored on a machine-readable medium or memory medium such as a semiconductor memory, a hard disk, or an optical memory, and used for carrying out, implementing, and/or controlling the steps of the method according to one of the specific embodiments described above, in particular when the program product or program is executed on a computer or a device.

Exemplary embodiments of the present invention are illustrated in the figures and explained in greater detail below.

### BRIEF DESCRIPTION OF THE DRAWINGS

FIG. 1 shows a cross-sectional view of a schematic illustration of an optical system that includes a lens for use with one exemplary embodiment of the present invention.

FIG. 2 shows a schematic view of the image sensor in a top view illustration for use with one exemplary embodiment of the present invention.

FIG. 3 shows a block diagram illustration of a system for preparing measured data provided by the image sensor designed as a set of light sensors arranged in two dimensions, including a processing unit according to one exemplary embodiment of the present invention.

FIG. 4A shows a schematic top view illustration of an image sensor for use with one exemplary embodiment of the present invention, in which light sensors of different light sensor types are arranged in a cyclic pattern;

FIG. 4B shows illustrations of different light sensor types, which may differ in shape, size, and function.

FIG. 4C shows illustrations of macrocells made up of interconnections of individual light sensor cells.

FIG. 4D shows an illustration of a complex unit cell, which represents the smallest repetitive surface-covering group of light sensors in the image sensor presented in FIG. 4A.

FIG. 5 shows a schematic top view illustration of an image sensor for use with one exemplary embodiment of the approach presented here, in which several light sensors having different shapes and/or functions are selected.

FIG. 6 shows a schematic top view illustration of an image sensor for use with one exemplary embodiment of the present invention, in which for light sensors surrounding a reference position, a highlighted group of 3×3 unit cells has been selected as light sensors that supply measured data.

FIG. 7 shows a schematic top view illustration of an image sensor for use with one exemplary embodiment of the present invention, in which for light sensors surrounding a reference position, areas with different extensions around the light sensor have been selected, shown here using the examples of a group of 3×3, 5×5, and 7×7 unit cells.

FIG. 8 shows a schematic illustration of a weighting value matrix for use with one exemplary embodiment of the present invention.

FIG. 9 shows a block diagram of a schematic procedure that may be carried out in a processing device according to FIG. 3.

FIG. 10 shows a flowchart of a method for processing measured data of an image sensor according to one exemplary embodiment of the present invention.

FIG. 11 shows a flowchart of a method for generating a weighting value matrix for weighting measured data of an image sensor according to one exemplary embodiment of the present invention.

FIG. 12 shows a schematic illustration of an image sensor, including a light sensor situated on the image sensor, for use in a method for generating a weighting value matrix for weighting measured data of an image sensor according to one exemplary embodiment of present invention.

### DETAILED DESCRIPTION OF EXAMPLE EMBODIMENTS

In the following description of advantageous exemplary embodiments of the present invention, identical or similar reference numerals are used for the elements having a similar action which are illustrated in the various figures, and a repeated description of these elements is dispensed with.

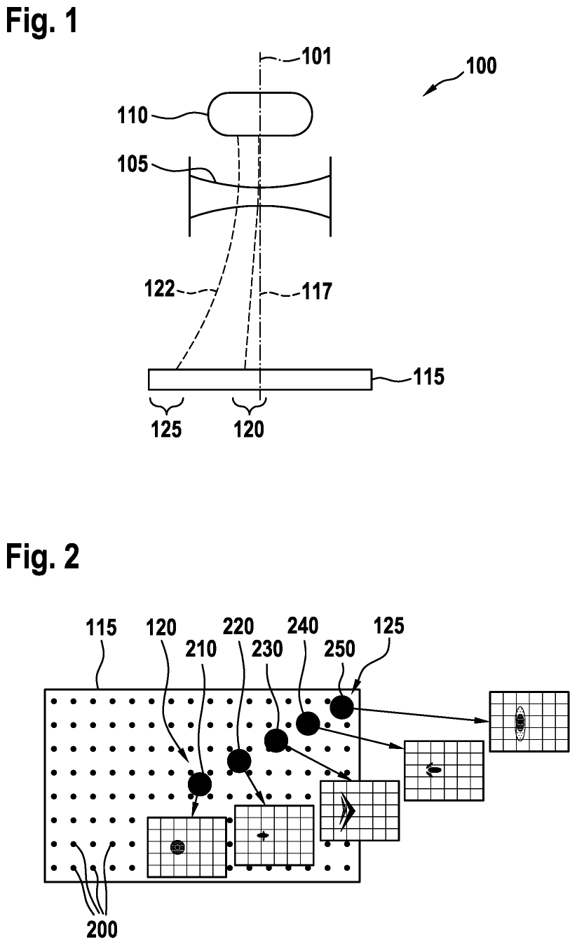

FIG. 1 shows a cross-sectional view of a schematic illustration of an optical system 100, including a lens 105, oriented in an optical axis 101, through which an object 110, illustrated as an example, is imaged onto an image sensor 115. It is apparent from the exaggerated depiction in FIG. 1 that a light beam 117 striking in a central area 120 of image sensor 115 takes a smaller path through lens 105 than a light beam 122 that passes through an edge area of lens 105 and also strikes in an edge area 125 of image sensor 115. In addition to an effect with regard to a brightness reduction in light beam 122 due to the longer path in the material of lens 105, it is also possible, for example, for a change in the optical imaging and/or a change in the spectral intensity with regard to different colors in this light beam 122 to be noted, compared, for example, to the corresponding values of light beam 117. It is also possible that image sensor 115 is not exactly planar, but instead has a slightly convex or concave design or is tilted with respect to optical axis 101, so that changes in the imaging during the recording of light beams 123 in edge area 125 of image sensor 115 likewise result. As a result, light beams that arrive in edge area 125 of image sensor 115 have properties that are detectable via recent sensors and that are different, even if only to a slight degree, from light beams that strike central area 120 on image sensor 115; such a change, for example in the local energy distribution or such different properties in the evaluation of the imaging of object 110, may possibly be imprecise due to the data delivered by image sensor 115, so that the measured data delivered by image sensor 115 may not be sufficiently usable for some applications. This problem arises in particular in high-resolution systems.

FIG. 2 shows a schematic view of image sensor 115 in a top view illustration, the change in the point imaging in central area 120, brought about by optical system 100 from FIG. 1, compared to the changes in the point imaging in edge area 125 now being illustrated in greater detail as an example. Image sensor 115 includes a plurality of light sensors 200 that are arranged in rows and columns in the form of a matrix, the exact configuration of these light sensors 200 being described in greater detail below. Also illustrated is a first area 210 in central area 120 of image sensor 115 in which, for example, light beam 117 from FIG. 1 strikes. It is apparent from the small diagram illustrated in FIG. 2, associated with first area 210 and representing an example of an evaluation of a certain spectral energy distribution that is detected in this area 210 of image sensor 115, that light beam 117 in first area 210 is imaged relatively sharply in a punctiform manner. In contrast, light beam 122, when it strikes area 250 of image sensor 115, is illustrated in a slightly “blurred” manner. If a light beam strikes one of image areas 220, 230, 240 of image sensor 115 situated in between, it is apparent from the associated diagrams that the spectral energy distribution may now assume a different shape, for example due to imaging by aspherical lenses, so that a precise detection of these colors and intensities is problematic. It is apparent from the particular associated diagrams that the energy of the incoming light beams is no longer sharply bundled, and may assume a different shape depending on the location, so that the imaging of object 110 by the measured data of image sensor 115, in particular in edge area 125 of image sensor 115, is problematic, as is apparent from the illustration in image area 250, for example. If the measured data delivered by image sensor 115 are now to be utilized for safety-critical applications, for example for the real-time detection of objects in the vehicle surroundings in the operational scenario of autonomous driving, a sufficiently precise detection of object 110 from the measured data delivered by image sensor 115 may no longer be possible. Although high-quality optical systems having much higher resolution may be used with more homogeneous imaging properties and higher-resolution image sensors, this requires greater technological complexity on the one hand, and increased costs on the other hand. Starting from this initial situation, with the approach presented here an option is now provided to prepare, via circuitry or numerical means, the measured data provided by the image sensors used thus far in order to achieve an improved resolution of the measured data delivered via these image sensors 115.

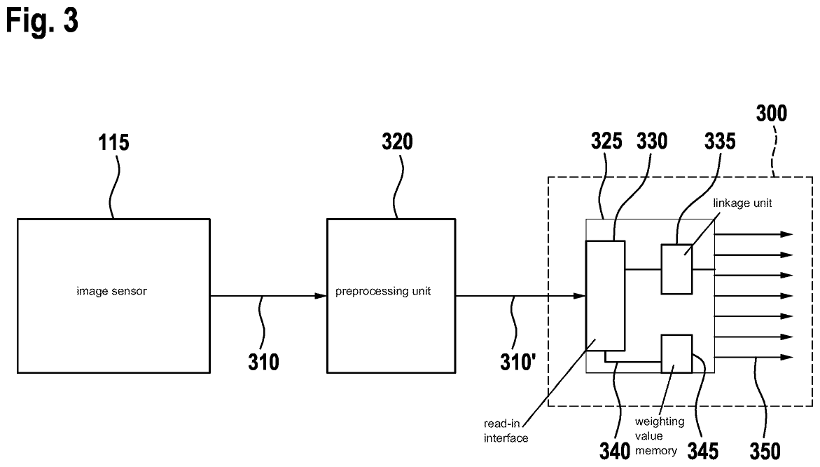

FIG. 3 shows a block diagram illustration of a system 300 for preparing measured data 310 that are provided to image sensor 115, designed as a light sensor matrix. Measured data 310 corresponding to the particular measured values from light sensors 200 of image sensor 115 from FIG. 2 are initially output by image sensor 115. The light sensors of image sensor 115, as described in even greater detail below, may be designed with different shapes, positions, and functions, and in addition to corresponding spectral values, i.e., color values, also detect the parameters intensity, brightness, polarization, phase, or the like. For example, such a detection may take place by covering individual light sensors of image sensor 115 with appropriate color filters, polarization filters, or the like, so that underlying light sensors of image sensor 115 may detect only a certain portion of the radiation energy having a certain property of the light striking the light sensor and provide it as a corresponding measured data value of this light sensor.

These measured data 310 may (optionally) initially be preprocessed in a unit 320. Depending on the design, the preprocessed image data, which may also be referred to as measured data 310′ for the sake of simplicity, may be supplied to a processing unit 325 in which, for example, the approach described in even greater detail below in the form of a grid base correction is implemented. For this purpose, measured data 310′ are read in via a read-in interface 330 and supplied to a linkage unit 335. At the same time, weighting values 340 may be read out from a weighting value memory 345 and likewise supplied to linkage unit 335 via read-in interface 330. For example, according to the even more detailed description below, measured data 310′ from the individual light sensors are then linked to weighting values 340 in linkage unit 335, and correspondingly obtained image data 350 may be further processed in one or multiple parallel or sequential processing units.

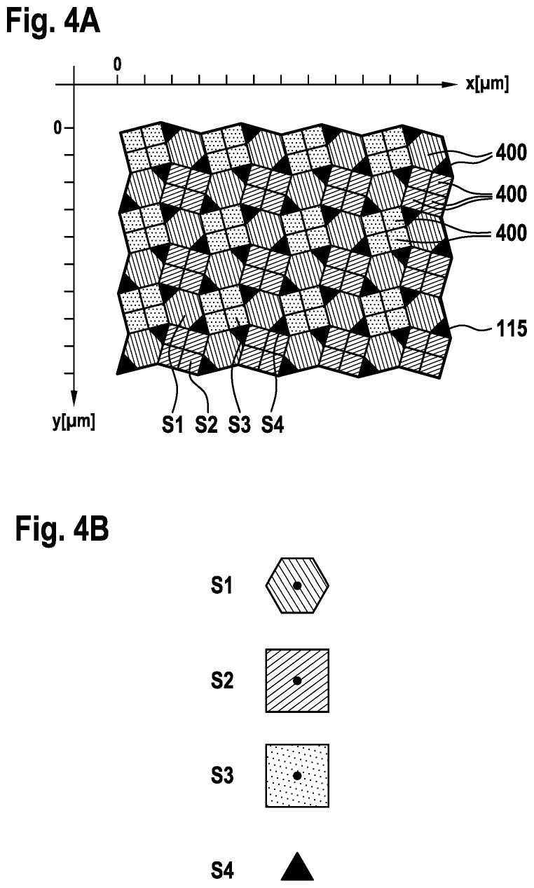

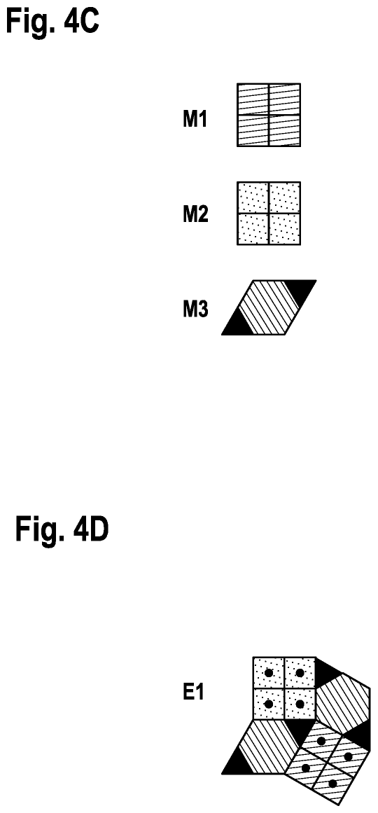

FIG. 4A shows a schematic top view illustration of an image sensor 115 in which light sensors 400 of different light sensor types are arranged in a cyclical pattern. Light sensors 400 may correspond to light sensors 200 from FIG. 2 and be implemented as pixels of image sensor 115. Light sensors 400 of the different light sensor types may, for example, have different sizes or different orientations, be equipped with different spectral filters, or detect different light properties.

Light sensors 400 may also be built up as sensor cells S1, S2, S3, or S4, as is apparent in FIG. 4B, each of which forms a sampling point for light that is incident on sensor cell S, it being possible to regard these sampling points as being situated in the center of gravity of the particular sensor cells. Individual sensor cells S may also be combined to form macrocells M, as illustrated in FIG. 4C, each of which forms a jointly addressable group of sensor cells S. A smallest repetitive group of sensor cells may be referred to as a unit cell, as illustrated, for example, in a complex shape in FIG. 4D. The unit cell may also have an irregular structure.

Individual light sensors 400 in FIG. 4 may occur multiple times in a unit cell or have unique properties. In the top view onto image sensor 115, light sensors 400 are also situated in a cyclic sequence in the vertical as well as the horizontal direction, and are situated on a grid that is characteristic for each sensor type and has the same or different periodicity. This vertical as well as horizontal direction of the arrangement of light sensors in a cyclic sequence may also be understood as a row- or column-wise arrangement of the light sensors. Regularity of the pattern may also result in modulo n; i.e., the structure is not visible in every row/column. Furthermore, each cyclically repeating arrangement of light sensors may be utilized by the method described here, although row- and column-like arrangements are common at the present time.

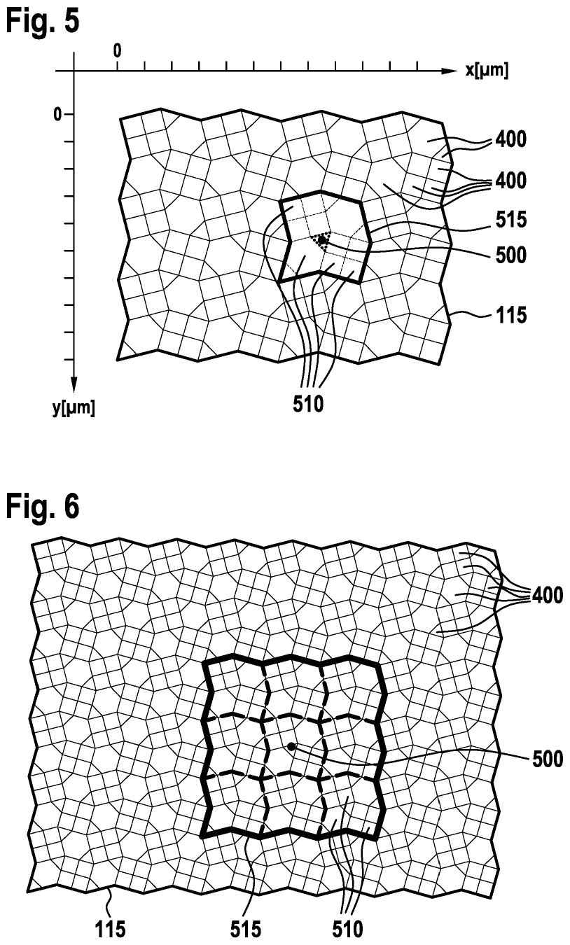

FIG. 5 shows a schematic top view illustration of an image sensor 115, in which a few light sensors 400 from a group 515 in the surroundings of a reference position 500 to be weighted are selected, and are weighted by a weighting, described in even greater detail below, in order to solve the above-mentioned problem that image sensor 115 does not deliver optimally usable measured data 310 or 310′ corresponding to FIG. 3. In particular, a reference position 500 is selected and multiple light sensors 510 in the surroundings are defined for this reference position 500, light sensors 510 (which may also be referred to as surroundings light sensors 510) being situated, for example, in a different column and/or a different row on image sensor 115 than reference position 500. A (virtual) position on image sensor 115 that is used as a reference point for a reconstruction of image data for this reference position to be imaged is utilized as reference position 500; i.e., the image data to be reconstructed from the measured data of surroundings light sensors 510 define the image parameters to be output or to be evaluated at this reference position in a subsequent method. Reference position 500 does not absolutely have to be bound to a light sensor; rather, image data 350 may also be ascertained for a reference position 500 that is situated between two light sensors 510 or completely outside an area of a light sensor 510. Thus, reference position 500 does not have to have a triangular or circular shape that is based, for example, on the shape of a light sensor 510. Light sensors of the same light sensor type as a light sensor at reference position 500 may be selected as surroundings light sensors 510. However, light sensors that represent a different light sensor type than the light sensor at reference position 500, or a combination of the same and different types of light sensors, may also be selected as surroundings light sensors 510 to be used for the approach presented here.

In FIG. 5, the surroundings of 14 single cells (8 squares, 4 triangles, and 2 hexagons) which have a relative position around reference point 500 are selected. The surroundings light sensors used for reconstructing the reference point do not necessarily have to adjoin one another or cover the entire surface of a sensor block 515.

In order to now improve a correction of the imaging properties of optical system 100 according to FIG. 1 or the detection accuracy of image sensor 115, the measured data of each of light sensors 400, for example a light sensor at reference position 500 and surroundings light sensors 510, are each weighted with a weighting value 340, and the weighted measured data thus obtained are linked together and associated with reference position 500 as image data 350. As a result, not only are image data 350 at reference position 500 based on information that has actually been detected or measured by a light sensor at reference position 500, but in addition, image data 350 associated with reference position 500 also contain information that has been detected or measured by surroundings light sensors 510. As a result, it is now possible to correct distortions or other imaging errors to a certain degree, so that the image data associated with reference position 500 now come very close to those measured data that a light sensor at reference position 500 would record or measure, for example without the deviations from an ideal light energy distribution or the imaging error.

In order to now be able to make the best correction possible of the imaging errors in the measured data via this weighting, weighting values 340 should be used that have been determined or trained as a function of the position of light sensor 400 on image sensor 115, with which particular weighting values 340 are associated. For example, weighting values 340 associated with light sensors 400 that are situated in edge area 125 of image sensor 115 have a higher value than weighting values 340 associated with light sensors 400 that are situated in central area 120 of image sensor 115. In this way, for example a higher attenuation, which is caused by a light beam 122 passing over a fairly long path through a material of an optical component such as lens 105, may be compensated for. In the subsequent linking of the weighted measured data for light sensors 400 or 510 in edge area 125 of image sensor 115, a state that would be obtained by the optical system or image sensor 115 without an imaging error may thus be back-calculated, when possible. In particular, deviations in the point imaging and/or color effects and/or luminance effects and/or moiré effects may thus be reduced with a skillful selection of the weights.

Weighting values 340, which may be used for such processing or weighting, are determined in advance in a training mode described in even greater detail below, and may be stored, for example, in memory 345 illustrated in FIG. 3.

FIG. 6 shows a schematic top view illustration of an image sensor 115, once again light sensors surrounding reference position 500 having likewise been selected as surroundings light sensors 510. In contrast to the selection of reference position 500 and surroundings light sensors 510 according to FIG. 5, 126 individual surroundings light sensors are now included in the computation of reference point 500, which also results in the option of compensating for errors created by a light energy distribution over fairly large surroundings.

It may also be noted that for the objective of different light properties at reference position 500, it is also possible to use different weighting values 340 for surroundings light sensor 510. This means, for example, that for a light sensor that is regarded as a surroundings light sensor 510, a first weighting value 340 may be used when the objective is to reconstruct a first light property at reference position 500, and for the same surroundings light sensor 510, a second weighting value 340 that is different from the first weighting value is used when a different light property is to be represented at reference position 500.

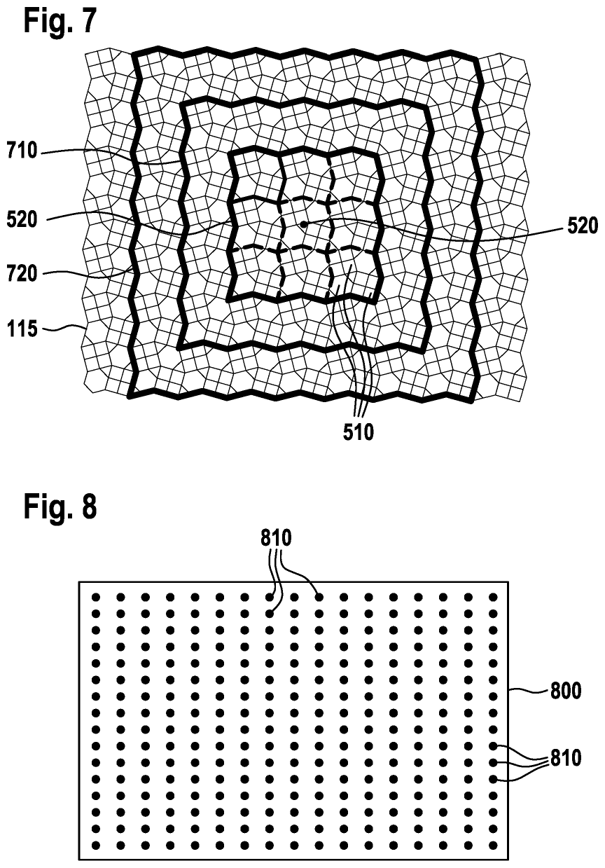

FIG. 7 shows a schematic top view illustration of an image sensor 115, once again light sensors surrounding reference position 500 having likewise been selected as surroundings light sensors 510. In contrast to the illustration from FIGS. 5 and 6, surroundings light sensors 510 according to the illustration from FIG. 7 are taken into account not just from one light sensor block 520, but rather, from the 350 individual surroundings light sensors of a 5×5 unit cell 710 in FIG. 7, or 686 individual surroundings light sensors of a 7×7 unit cell 720 in FIG. 7. Surroundings having an arbitrary size are selectable; the shape is not limited to the shape of the unit cells and their multiples, and in addition not all surroundings light sensors have to be used for reconstructing the reference point. In this way, additional information from the larger surroundings around reference position 500 may be utilized to allow compensation for imaging errors of measured data 310 that are recorded by image sensor 115, as the result of which the corresponding resolution of the imaging of the object or the precision of image data 350 may be even further increased.

To allow to the greatest extent possible a reduction of the size of memory 345 (which may be a cache memory, for example) necessary for carrying out the approach presented here, according to a further exemplary embodiment it is possible for a corresponding weighting value 340 for each of light sensors 400 to not be stored in memory 345. Rather, for example for every nth light sensor 400 of a corresponding light sensor type on image sensor 115, a weighting value 340 associated with this position of light sensor 400 may be stored as a weighting reference value in memory 345.

FIG. 8 shows a schematic illustration of a weighting value matrix 800, the points illustrated in weighting value matrix 800 corresponding to weighting reference values 810 as weighting values 340 that are associated with every nth light sensor 400 of the corresponding light sensor type (with which weighting value matrix 800 is associated) at the corresponding position of light sensor 400 on image sensor 115 (i.e., in edge area 125 or in central area 120 of image sensor 115). Those weighting values 340 that are associated with light sensors 400 on image sensor 115, situated between two light sensors with which a weighting reference value 810 is associated in each case, may then be ascertained, for example, by a (for example, linear) interpolation from neighboring weighting reference values 810. In this way (for example, for each light sensor type), a weighting value matrix 800 may be used that requires a much smaller memory size than if a correspondingly associated weighting value 340 had to be stored for each light sensor 400.

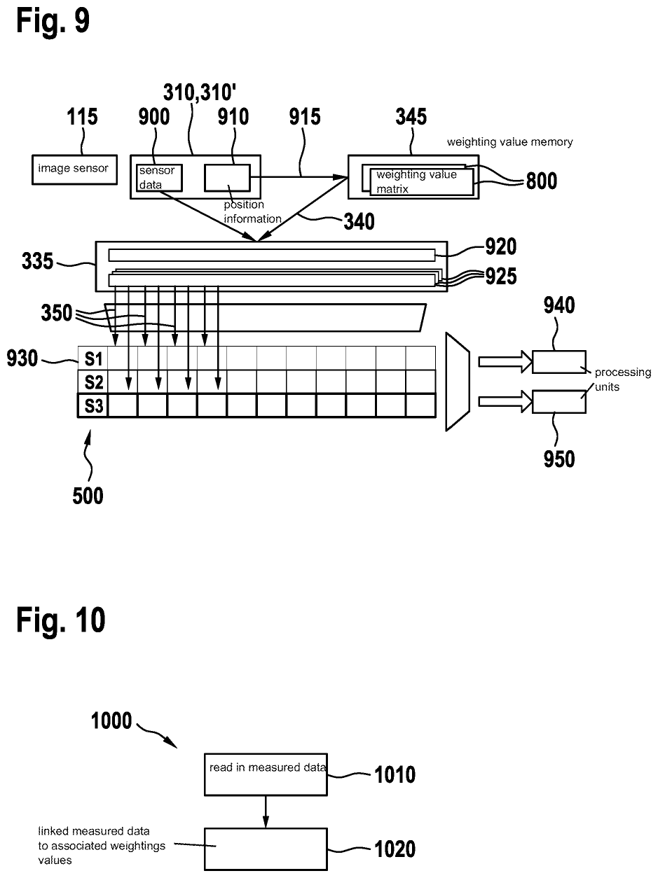

FIG. 9 shows a block diagram of a schematic procedure that may be carried out in a processing device 325 according to FIG. 3. Image sensor 115 (or preprocessing unit 320) initially reads in measured data 310 (or preprocessed image data 310′), which as measured data or sensor data 900 form the measured data, which actually deliver information and have been measured or detected by individual light sensors 400. At the same time, position information 910 is also known from these measured data 310 or 310′, from which it may be inferred at which position light sensor 400 in question is situated in image sensor 115 that has delivered sensor data 900. For example, it may be deduced from this position information 910 whether light sensor 400 in question is situated in edge area 125 of image sensor 115, or rather, in central area 120 of image sensor 115. Based on this position information 910, which is sent to memory 345 via a position signal 915, for example, all weighting values 340 that are available in memory 345 for position 910 are ascertained and output to linkage unit 335. The same sensor measured value may be assigned a different weight in each case for different reference positions and for light properties to be reconstructed. In memory 345, all weighting value matrices 800 are used according to their weighting of position 910, the weighting value matrix in each case containing weighting values 340 or weighting reference values 810 that are associated with the light sensor type from which measured data 310 or 310′ in question or sensor data 900 in question have been delivered. For reference positions for which weighting value matrix 800 does not contain a specific value, the weights for position 910 are interpolated.

In processing unit 335, measured data 310 or 310′ that are weighted in each case with associated weighting values 340, or sensor data 900 that are weighted with associated weighting values 340, are initially collected in a collection unit 920 and sorted according to their reference positions and reconstruction tasks, and the collected and sorted weighted measured data are subsequently summed in their group in an addition unit 925, and the obtained result, as weighted image data 350, is associated with the respective underlying reference positions and reconstruction task 500.

The lower portion of FIG. 9 shows one very advantageous implementation of the ascertainment of image data 350. Output buffer 930 is situated at the level, for example, of light sensors 510 contained in the vicinity. Each of surroundings light sensors 510 acts (with different weighting) on many reference positions 500. When all weighted values are present for a reference position 500 (illustrated as columns in FIG. 9), summation is carried out along the columns and the result is output. The columns may then be used for a new reference value (circular buffer indexing). This yields the advantage that each measured value is processed only once, but acts on many different output pixels (as reference positions 500), which is illustrated by the various columns. As a result, the intended rationale from FIGS. 4 through 7 is “inverted,” thus saving hardware resources. The height of the memory (number of rows) is based on the quantity of surroundings pixels, and for each surroundings pixel should include a row, and the width of the memory (number of columns) is to be designed according to the quantity of those reference positions that may be influenced by each measured value.

The values ascertained from output buffer 930 may then be further processed in one or multiple units, such as units 940 and 950 illustrated in FIG. 9.

FIG. 10 shows a flowchart of one exemplary embodiment of the approach presented here, as a method 1000 for processing measured data of an image sensor. Method 1000 includes a step 1010 of reading in measured data that have been recorded by light sensors (surroundings light sensors) in the surroundings of a reference position on the image sensor, the light sensors being situated around the reference position on the image sensor, and weighting values also being read in that are associated with each piece of measured data of the light sensors in the surroundings of a reference position, the weighting values for light sensors situated at an edge area of the image sensor being different from weighting values for light sensors situated in a central area of the image sensor, and/or the weighting values being a function of a position of the light sensors on the image sensor. Lastly, method 1000 includes a step 1020 of linking the measured data of the light sensors to the associated weighting values in order to obtain image data for the reference position.

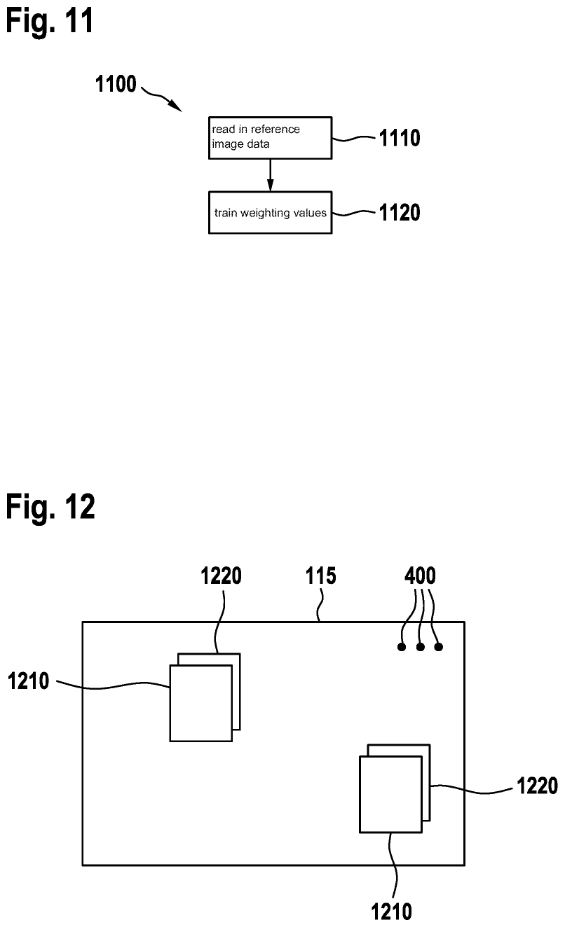

FIG. 11 shows a flowchart of one exemplary embodiment of the approach presented here, as a method 1100 for generating a weighting value matrix for weighting measured data of an image sensor. Method 1100 includes a step 1110 of reading in reference image data for reference positions of a reference image, and training measured data of a training image, and of a starting weighting value matrix. In addition, method 1100 includes a step 1120 of training weighting values contained in the starting weighting value matrix, using the reference image data and the training measured data, in order to obtain the weighting value matrix, a linkage of training measured data of the light sensors, each weighted with a weighting value, being formed and compared to the reference measured data for the corresponding reference position, using light sensors that are situated around the reference position on the image sensor.

By use of such an approach, a weighting value matrix may be obtained that provides in each case corresponding, different weighting values for a light sensor at different positions on the image sensor to allow the most optimal correction possible of distortions or imaging errors in the measured data of the image sensor, as may be implemented by the above-described approach for processing measured data of an image sensor.

FIG. 12 shows a schematic illustration of an image sensor 115 that includes light sensors 400 situated on image sensor 115. In order to now obtain weighting value matrix 800 (using either weighting reference values 810 or direct weighting values 340, each of which is associated with one of light sensors 400), as illustrated in FIG. 8, for example, a reference image 1210 (from when weighting value matrix 800 is to be ascertained) and a training image 1220 (which represents initial measured data 310 of image sensor 115 without using weighting values), may now be used. An attempt should be made to determine the weighting values in such a way that the statements regarding the above-described method for processing measured data 310 when recording training image 1220, taking into account the weighting values, result in processed measured data 350 for individual light sensors 400 of image sensor 115 that correspond to a recording of measured data 310 of reference image 1210. For example, the interpolation of values 800 is also already taken into account.

In order to also minimize numerical and/or circuitry-related complexity, it is also possible for an image that represents an image detail that is smaller than an image that is detectable by image sensor 115 to be read in, in each case as a reference image and as a training image, as illustrated in FIG. 12. It is also possible to use multiple different partial training images 1220 that are used for determining the weighting values for achieving measured data of correspondingly associated partial reference images 1210. Partial training images 1220 should be imaged congruently with partial reference images 1210 on image sensor 115. By use of such a procedure, it is also possible via an interpolation, for example, to determine weighting values that are associated with alternating light sensors 400 of image sensor 115, which are situated in an area of image sensor 115 that is not covered by a partial reference image 1210 or a partial training image 1220.

In summary, it is noted that the approach presented here in accordance with example embodiments of the present invention provides a method and its possible implementation in hardware. The method is used for the comprehensive correction of multiple error classes of image errors that result from the physical image processing chain (optical system and imager, atmosphere, windshield, motion blur). In particular, the method is provided for correcting wavelength-dependent errors that arise during sampling of the light signal by the image sensor and their correction, the so-called “demosaicing.” In addition, errors that arise via the optical system are corrected. This applies for manufacturing tolerance-related errors as well as for changes in the imaging behavior which during operation are induced thermally or caused by air pressure. Thus, for example, the red-blue error in the center of the image is generally to be corrected differently than that at the edge of the image, and differently at high temperatures than at low temperatures. The same applies for an attenuation of the image signal at the edge (“shading”).

The “grid based demosaicing” hardware block, provided by way of example for the correction, in the form of the processing unit may simultaneously correct all of these errors, and in addition, with a suitable light sensor structure may also maintain the quality of the geometric resolution and of the contrast more satisfactorily than conventional methods.

In addition, an explanation is provided for how a training method for determining the parameters might look. The method makes use of the fact that the optical system has a point response whose action takes place primarily in limited spatial surroundings. It may thus be deduced that a first approximation correction may take place via a linear combination of the measured values of the surroundings. This first or linear approximation requires less computing power, and is similar to present preprocessing layers of neural networks.

Particular advantages may be achieved for present and future systems via a direct correction of image errors directly in the imager unit. Depending on the processing logic system situated downstream, this may have a superlinear positive effect on the downstream algorithms, since due to the correction, image errors no longer have to be considered in the algorithms, which is a major advantage in particular for learning methods. The approach presented here shows how this method may be implemented in a more general form as a hardware block diagram. This more general methodology also allows features other than the visual image quality to be enhanced. For example, the edge features, important for the machine vision, could be directly highlighted when the measured data stream is not provided for a displaying system.

If an exemplary embodiment includes an “and/or” linkage between a first feature and a second feature, this may be construed in such a way that according to one specific embodiment, the exemplary embodiment has the first feature as well as the second feature, and according to another specific embodiment, the exemplary embodiment either has only the first feature or only the second feature.

1-14. (canceled)

15. A method for processing measured data of an image sensor, the method comprising the following steps:
reading in measured data that have been recorded by light sensors in surroundings of a reference position on the image sensor, the light sensors being situated around the reference position on the image sensor, and reading in weighting values, each of the weighting values being associated with the measured data of the light sensors in the surroundings of the reference position, the weighting values for light sensors situated at an edge area of the image sensor differing from the weighting values for light sensors situated in a central area of the image sensor and/or the weighting values being a function of a position of the light sensors on the image sensor; and
linking the measured data of the light sensors to the associated weighting values to obtain image data for the reference position.

16. The method as recited in claim 15, wherein in the step of reading in, the measured data are read in from the light sensors, each of the light sensors being situated in a different row and/or a different column on the image sensor in relation to the reference position, the light sensors completely surrounding the reference position.

17. The method as recited in claim 15, wherein in the reading in step, the measured data are read in from the light sensors, each of the light sensors being configured to record measured data in different parameters, colors and/or exposure times and/or brightnesses being parameters.

18. The method as recited in claim 15, further comprising:
ascertaining the weighting values using an interpolation of weighting reference values, the weighting reference values being associated with those of the light sensors situated at a predefined distance from one another on the image sensor.

19. The method as recited in claim 15, wherein the reading in step and the linking step are carried out repeatedly, in the repeatedly carried out reading in step, the measured data of the light sensors are read in, which are situated at a different position on the image sensor than the measured data of the light sensors from which measured data were read in in a preceding reading in step.

20. The method as recited in claim 15, wherein the read in step and the linking step are carried out repeatedly, in the repeatedly carried out reading in step, the measured data of the light sensors in the surroundings of the reference position are read out, which were also read in in a preceding reading in step, and in the repeatedly carried out reading in step, different weighting values for the measured data are read in than the weighting values that were read in in the preceding reading in step.

21. The method as recited in claim 15, wherein the measured data from the light sensors of different light sensor types are read in in the reading in step.

22. The method as recited in claim 15, wherein in the reading in step, the measured data are read in from light sensors of an image sensor having, at least in part, a cyclic arrangement of light sensor types as light sensors, and/or the measured data are read in from light sensors having different sizes on the image sensor, and/or the measured data is read in from light sensors that each include different light sensor types that occupy a different surface on the image sensor.

23. The method as recited in claim 15, wherein in the linking step, the measured data of the light sensors that are weighted with the associated weighting values are summed to obtain the image data for the reference position.

24. A method for generating a weighting value matrix for weighting measured data of an image sensor, the method comprising the following steps:
reading in reference image data for reference positions of a reference image and training measured data of a training image, and of a starting weighting value matrix; and
training weighting values contained in the starting weighting value matrix, using the reference image data and the training measured data to obtain the weighting value matrix, a linkage being formed from training measured data of the light sensors, each weighted with a weighting value, and being compared to the reference measured data for the corresponding reference position, using those of the light sensors that are situated around the corresponding reference position on the image sensor.

25. The method as recited in claim 24, wherein in the reading in step, an image that represents an image detail that is smaller than an image that is detectable by the image sensor is read in in each case as a reference image and as a training image.

26. A processing device configured to process measured data of an image sensor, the processing device configured to:
read in measured data that have been recorded by light sensors in surroundings of a reference position on the image sensor, the light sensors being situated around the reference position on the image sensor, and reading in weighting values, each of the weighting values being associated with the measured data of the light sensors in the surroundings of the reference position, the weighting values for light sensors situated at an edge area of the image sensor differing from the weighting values for light sensors situated in a central area of the image sensor and/or the weighting values being a function of a position of the light sensors on the image sensor; and
link the measured data of the light sensors to the associated weighting values to obtain image data for the reference position.

27. A processing device configured to generate a weighting value matrix for weighting measured data of an image sensor, the processing device configured to:
read in reference image data for reference positions of a reference image and training measured data of a training image, and of a starting weighting value matrix; and
train weighting values contained in the starting weighting value matrix, using the reference image data and the training measured data to obtain the weighting value matrix, a linkage being formed from training measured data of the light sensors, each weighted with a weighting value, and being compared to the reference measured data for the corresponding reference position, using those of the light sensors that are situated around the corresponding reference position on the image sensor

28. A non-transitory machine-readable memory medium on which is stored a computer program for processing measured data of an image sensor, the computer program, when executed by a processing device, causing the processing device to perform the following steps:
reading in measured data that have been recorded by light sensors in surroundings of a reference position on the image sensor, the light sensors being situated around the reference position on the image sensor, and reading in weighting values, each of the weighting values being associated with the measured data of the light sensors in the surroundings of the reference position, the weighting values for light sensors situated at an edge area of the image sensor differing from the weighting values for light sensors situated in a central area of the image sensor and/or the weighting values being a function of a position of the light sensors on the image sensor; and
linking the measured data of the light sensors to the associated weighting values to obtain image data for the reference position.
